(19) United States
(12) Patent Application Publication
(10) Pub. No.: US 2011/0198322 A1
(43) Pub. Date: Aug. 18, 2011

(54) IN-LINE METROLOGY METHODS AND SYSTEMS FOR SOLAR CELL FABRICATION

(75) Inventors: Antoine P. Manens, Saratoga, CA (US); Ting-Ruei Shiu, Mountain View, CA (US); Bassam Shamoun, Fremont, CA (US); Wei-Yung Hsu, Santa Clara, CA (US); Manivannan Thothadri, Mountain View, CA (US)

(73) Assignee: Applied Materials, Inc., Santa Clara, CA (US)

(21) Appl. No.: 12/851,471

(22) Filed: Aug. 5, 2010

Related U.S. Application Data
(60) Provisional application No. 61/231,962, filed on Aug. 6, 2009.

(51) Int. Cl. B23K 26/00; G01J 1/42; H04N 7/18

(52) U.S. Cl. 219/121.72; 356/218; 348/94; 219/121.67

(57) ABSTRACT

In-line metrology methods and systems for use with laser-scribing systems used in solar-cell fabrication are disclosed. Such methods and systems can involve a variety of components, for example, a device for measuring the amount of power input to a laser, a power meter for measuring laser output power, a beam viewer for measuring aspects of a laser beam, a height sensor for measuring a workpiece height, a microscope for measuring workpiece features formed by the laser-scribing system, and a system for monitoring a laser-scribing system and annunciating a warning(s) and/or an error message(s) when operational limits are exceeded. In-line metrology methods can also include the processing of output beam reflections so as to track beam drift over time and/or provide for focusing of an imaging device.

### CROSS-REFERENCES TO RELATED APPLICATIONS

This application claims the benefit of U.S. Prov. Patent Application No. 61/231,962 filed Aug. 6, 2009 and titled “IN-LINE METROLOGY METHODS AND SYSTEMS FOR SOLAR CELL FABRICATION,” which is incorporated herein by reference for all purposes.

### BACKGROUND

Many embodiments described herein relate generally to in-line metrology methods and systems, and more particularly to in-line metrology methods and systems for use during the fabrication of solar-cell panel assemblies. These methods and systems can be particularly effective in scribing single junction solar cells and thin-film multi junction solar cells.

Current methods for forming thin-film solar cells involve depositing or otherwise forming a plurality of layers on a substrate, for example, a glass, metal or polymer substrate suitable to form one or more p-n junctions. An example of a solar cell has an oxide layer (e.g., a transparent conductive oxide (TCO)) deposited on a substrate, followed by an amorphous-silicon layer and a metal-back layer. Examples of materials that can be used to form solar cells, along with methods and apparatus for forming the cells, are described, for example, in U.S. Pat. No. 7,582,515, issued Sep. 1, 2009, entitled “MULTI-JUNCTION SOLAR CELLS AND METHODS AND APPARATUSES FOR FORMING THE SAME,” which is hereby incorporated herein by reference. When a panel is being formed from a large substrate, a series of scribe lines can be used within each layer to delineate the individual cells. The scribe lines are formed by laser ablating material from a workpiece, which consists of a substrate having at least one layer deposited thereon. The laser-scribing process may occur with the workpiece sitting supported on top of a planar stage or bed.

High throughput laser-scribing systems typically include a number of complex component assemblies, which may operationally degrade over time and/or fail to function. In at least some instances, degradation of one or more laser-scribing system component assemblies may result the production of discrepant solar-cell panel assemblies. Such discrepant solar-cell panel assemblies may exhibit lower efficiency and, in some instances, fail to function.

Accordingly, it is desirable to develop methods and systems that provide for the monitoring of laser-scribing systems used in the formation of solar-cell panel assemblies to detect degradations and/or malfunctions of the laser-scribing systems so that timely corrective action can be taken.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Many embodiments described herein relate generally to in-line metrology methods and systems, and more particularly to in-line metrology methods and systems for use during the fabrication of solar cell panel assemblies. Such methods and systems can involve a variety of components used to monitor the operation of a laser-scribing system. These monitoring components include, for example, a power measuring device for measuring the amount of power input to a laser, a power meter for measuring laser output power, a beam viewer for measuring aspects of a laser beam, a height sensor for measuring a relative height of a workpiece, a microscope for measuring workpiece features formed by the laser-scribing system, and a system for monitoring the laser-scribing system and annunciating a warning(s) and/or an error message(s) when operational parameters exceed limits. In-line metrology methods can also include the processing of returned reflections from the laser-scanning assembly so as to track beam drift over time and/or provide for focusing of an imaging device. Such methods and systems can be used to monitor a laser-scribing system so that timely corrective action can be taken in response to a detected degradation(s) and/or a malfunction(s). Such timely corrective action may provide for reduced fabrications costs through the reduction of laser-scribing system maintenance costs and/or increased solar-panel assembly quality through the reduction of the number/severity of solar-panel assembly defects.

### BRIEF DESCRIPTION OF THE DRAWINGS

A further understanding of the nature and advantages of the invention may be realized by reference to the remaining portions of the specification and the drawings wherein like reference numerals are used throughout the several drawings to refer to similar components. The Figures are incorporated into the detailed description portion of the invention.

FIG. 1 illustrates laser-scribed lines in a thin-film solar-cell assembly.

FIG. 2 illustrates a perspective view of a laser-scribing system, in accordance with many embodiments.

FIG. 3 illustrates a side view of a laser-scribing system, in accordance with many embodiments.

FIG. 4 illustrates an end view of a laser-scribing system, in accordance with many embodiments.

FIG. 5 illustrates a top view of a laser-scribing system, in accordance with many embodiments.

FIG. 6 illustrates a set of laser assemblies, in accordance with many embodiments.

FIG. 7 illustrates components of a laser assembly, in accordance with many embodiments.

FIG. 8 illustrates the generation of multiple scan areas, in accordance with many embodiments.

FIG. 9 diagrammatically illustrates the integration of an imaging device with a laser-scanning assembly, in accordance with many embodiments.

FIG. 10 illustrates the use of a beam viewer to measure aspects of a laser beam, in accordance with many embodiments.

FIG. 11 illustrates stages that can be used to move a workpiece and laser-scribing system components, in accordance with many embodiments.

FIG. 12 is a flow chart of a method for using a power meter for inline metrology in a laser-scribing system, in accordance with many embodiments.

FIG. 13 is a flow chart of a method for using a beam viewer for inline metrology in a laser-scribing system, in accordance with many embodiments.

FIG. 14 is a flow chart of a method for using a height sensor for inline metrology in a laser-scribing system, in accordance with many embodiments.

FIG. 15 is a flow chart of a method for using a microscope for inline metrology in a laser-scribing system, in accordance with many embodiments.

FIG. 16 diagrammatically illustrates the operation of a scanner having a telecentric lens, in accordance with many embodiments.

FIG. 17 diagrammatically illustrates the imaging of a reflection from a workpiece of a scanned laser beam projected from a scanner having a telecentric lens, in accordance with many embodiments.

FIG. 18 is a table of image centroid pixel locations for a number of scanner positions for two different imaging device focus positions, in accordance with many embodiments.

FIG. 19 graphically illustrates the impact of telecentricity errors in a telecentric scan lens model for 100 mm defocus, in accordance with many embodiments.

FIG. 20 is a simplified block diagram illustrating imaging device based in-line metrology operations for a laser-scribing system, in accordance with many embodiments.

FIG. 21 is a simplified diagram of a monitoring system for a laser-scribing system, in accordance with many embodiments.

### DETAILED DESCRIPTION

Methods and systems in accordance with many embodiments of the present disclosure can be used for in-line monitoring of a laser-scribing system used to fabricate solar-cell panel assemblies so as to detect operational degradations. Such in-line monitoring may be used to trigger timely corrective action. Such corrective action may reduced laser-scribing system maintenance costs and/or the number/severity of fabrication discrepancies in solar-cell panel assemblies.

Solar Panel Fabrication

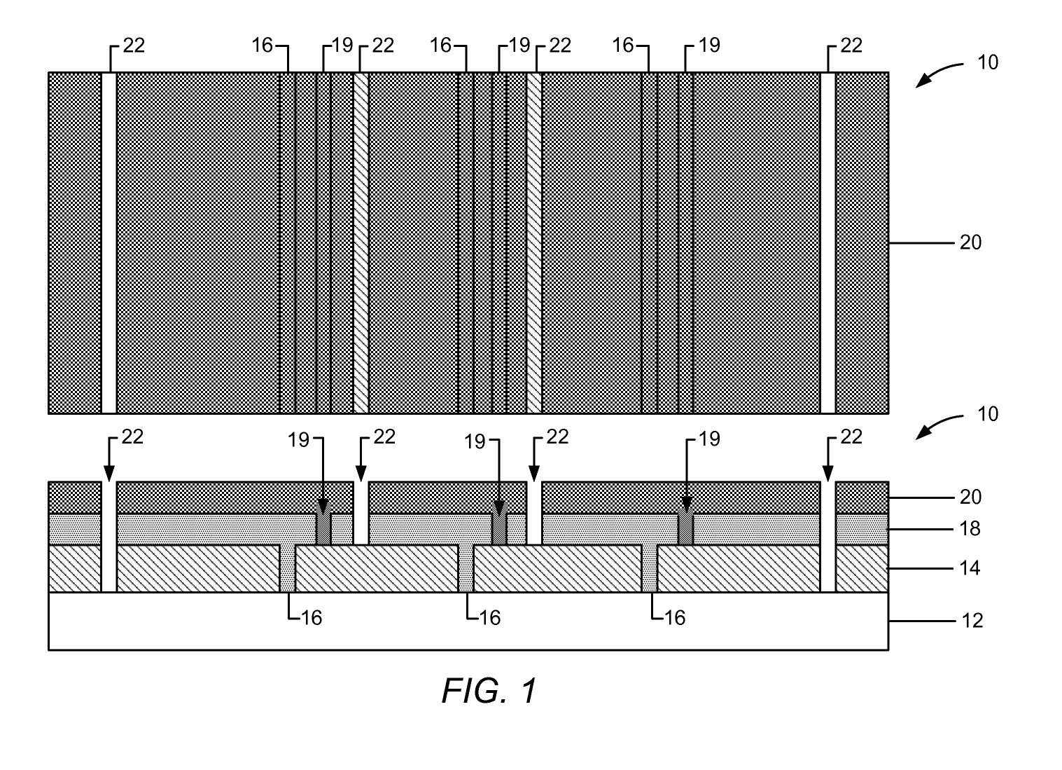

When a solar panel is being formed from a large substrate, for example, a series of laser-scribed lines can be used within each layer to delineate the individual cells. FIG. 1 illustrates laser-scribed lines within an example assembly 10 used in a thin-film solar cell. During the formation of the assembly 10, a glass substrate 12 has a transparent conductive oxide (TCO) layer 14 deposited thereon. The TCO layer 14 is then separated into isolated regions via laser-scribed P1 lines 16. Next, an amorphous-silicon (a-Si) layer 18 is deposited on top of the TCO layer 14 and within the scribed P1 lines 16. A second set of lines (“P2” lines 19) are then laser scribed in the amorphous-silicon (a-Si) layer 18. A metal-back layer 20 is then deposited on top of the amorphous-silicon (a-Si) layer 18 and within the scribed P2 lines 19. A third set of lines 22 (“P3” lines) are laser scribed as shown. While much of the area of the resultant assembly constitutes active regions of solar cells of the panel, various regions lying between the P1 16 and P3 22 scribe lines constitute non-active solar-cell area, also known as “the dead zone”.

In order to optimize the efficiency of these solar cell panels, the non-active solar cell area (i.e., the “dead zone”) of these panels should be minimized. To minimize the dead zone, each P3 line 22 should be aligned as close as possible to a corresponding P1 line 16. As will be discussed in more detail below, line sensing optics can be used to adjust the scribing of lines to minimize the dead zone area on an assembly.

Laser-Scribing Systems

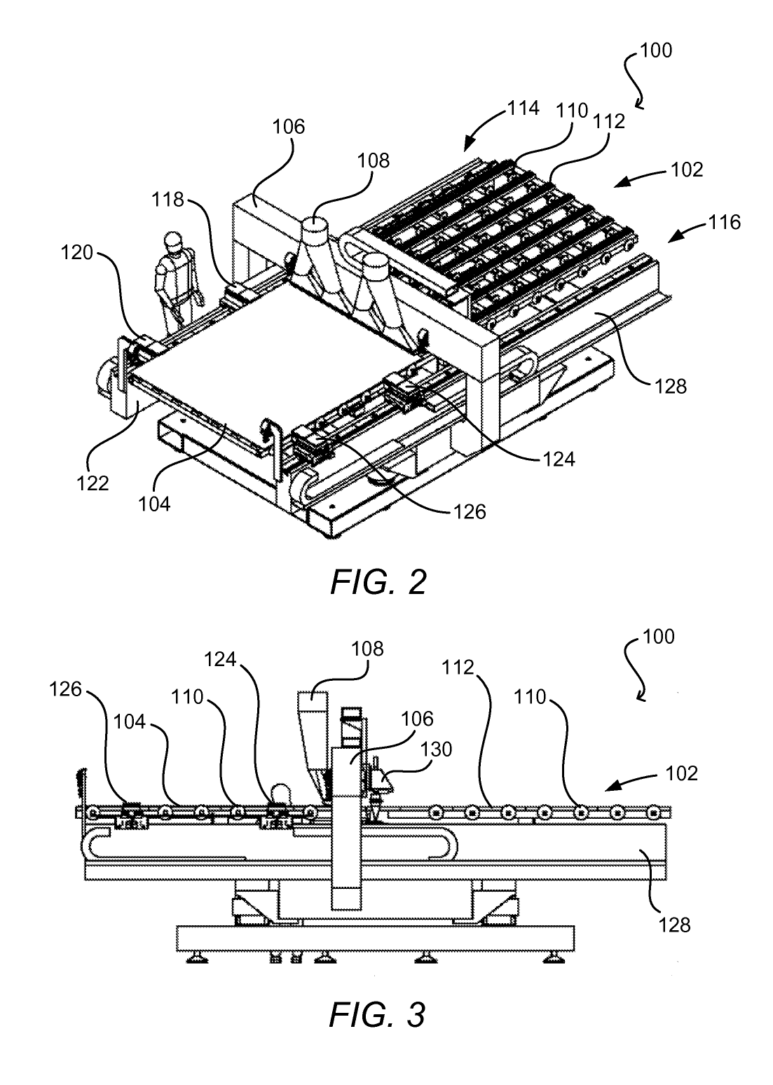

FIG. 2 illustrates an example of a laser-scribing system 100 in accordance with many embodiments. The system includes a translation stage or bed 102, as described herein, which may be leveled, for receiving and maneuvering a workpiece 104, for example, a substrate having at least one layer deposited thereon. In one example, the workpiece 104 is able to move along a single directional vector (i.e., for a Y-stage) at various rates (e.g., from 0 m/s to 2 m/s or faster). In many embodiments, the workpiece will be aligned to a fixed orientation with the long axis of the workpiece substantially parallel to the motion of the workpiece in the device, for reasons described elsewhere herein. The alignment can be aided by the use of cameras or imaging devices that acquire marks on the workpiece. In this example, the lasers and optics (shown in subsequent figures) are positioned beneath the workpiece and opposite a bridge 106 holding part of an exhaust mechanism 108 for extracting material ablated or otherwise removed from the substrate during the scribing process. The workpiece 104 can be loaded onto a first end of the stage 102 with the substrate side down (towards the lasers) and the layered side up (towards the exhaust). The workpiece is initially received onto an array of rollers 110 and can then be supported by a plurality of parallel air bearings 112 for supporting and allowing translation of the workpiece, although other bearing- or translation-type objects can be used to receive and translate the workpiece as known in the art. In this example, the array of rollers all point in a single direction, along the direction of propagation of the substrate, such that the workpiece 104 can be moved back and forth in a longitudinal direction relative to the laser assembly.

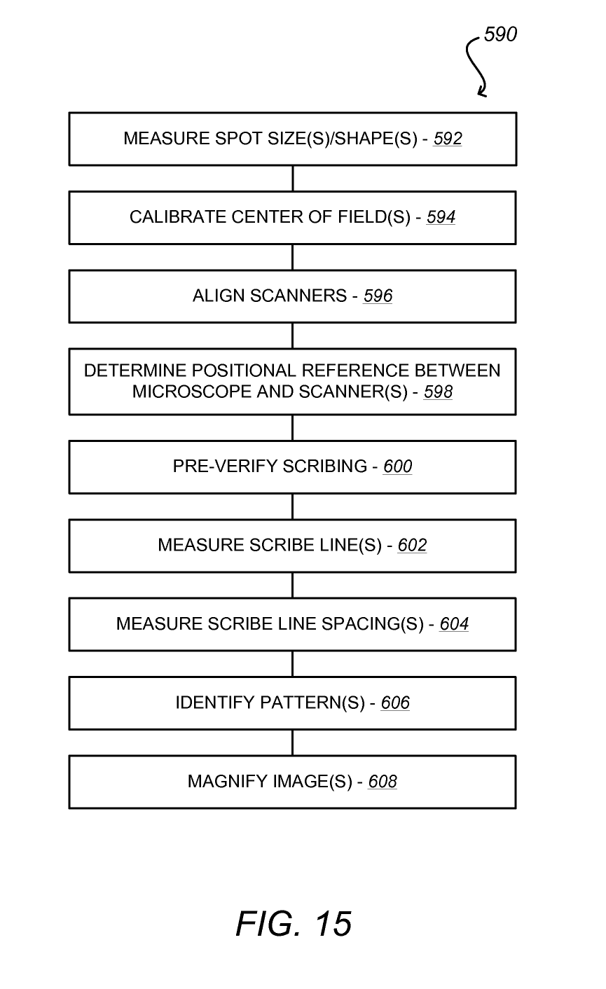

The system 100 includes a controllable drive mechanism for controlling a direction and translation velocity of the workpiece 104 on the stage 102. The controllable drive mechanism includes two Y-direction stages, a stage Y1 114 and stage Y2 116, disposed on opposite sides of the workpiece 104. The stage Y1 114 includes two X-direction stages (stage XA1 118 and stage XA2 120) and a Y1-stage support 122. The stage Y2 116 includes two X-direction stages (stage XB1 124 and stage XB2 126) and a Y2-stage support 128. The four X-direction stages 118, 120, 124, 126 include workpiece grippers for holding the workpiece 104. Each of the Y-direction stages 114, 116 include one or more air bearings, a linear motor, and a position sensing system. As will be described in more detail below with reference to FIGS. 14 and 15, the X-direction stages 118, 120, 124, 126 provide for more accurate workpiece movement by correcting for straightness variations that exist in the Y-direction stage supports 122, 128. The stage 102, bridge 106, and the Y-stage supports 122, 128, can be made out of at least one appropriate material, for example, the Y-stage supports 122, 128 of granite.

The movement of the workpiece 104 is also illustrated in the side view of the system 100 shown in FIG. 3, where the workpiece 104 moves back and forth along a vector that lies in the plane of the figure. Reference numbers are carried over between figures for somewhat similar elements for purposes of simplicity and explanation, but it should be understood that this should not be interpreted as a limitation on the various embodiments. As the workpiece is translated back and forth on the stage 102 by the Y-direction stages, a scribing area of the laser assembly effectively scribes from near an edge region of the substrate to near an opposite edge region of the substrate. The translation of the workpiece is facilitated in part by the movement of stage Y2 (i.e., by the movement of X-direction stages 124, 126 along the Y2-stage support 128).

In order to ensure that the scribe lines are being formed properly, additional devices can be used. For example, an imaging device can image at least one of the lines after scribing. Further, a beam profiling device 130 can be used to calibrate the beams between processing of substrates or at other appropriate times. In many embodiments where scanners are used, for example, which may drift over time, a beam profiler allows for calibration of the beam and/or adjustment of a beam position.

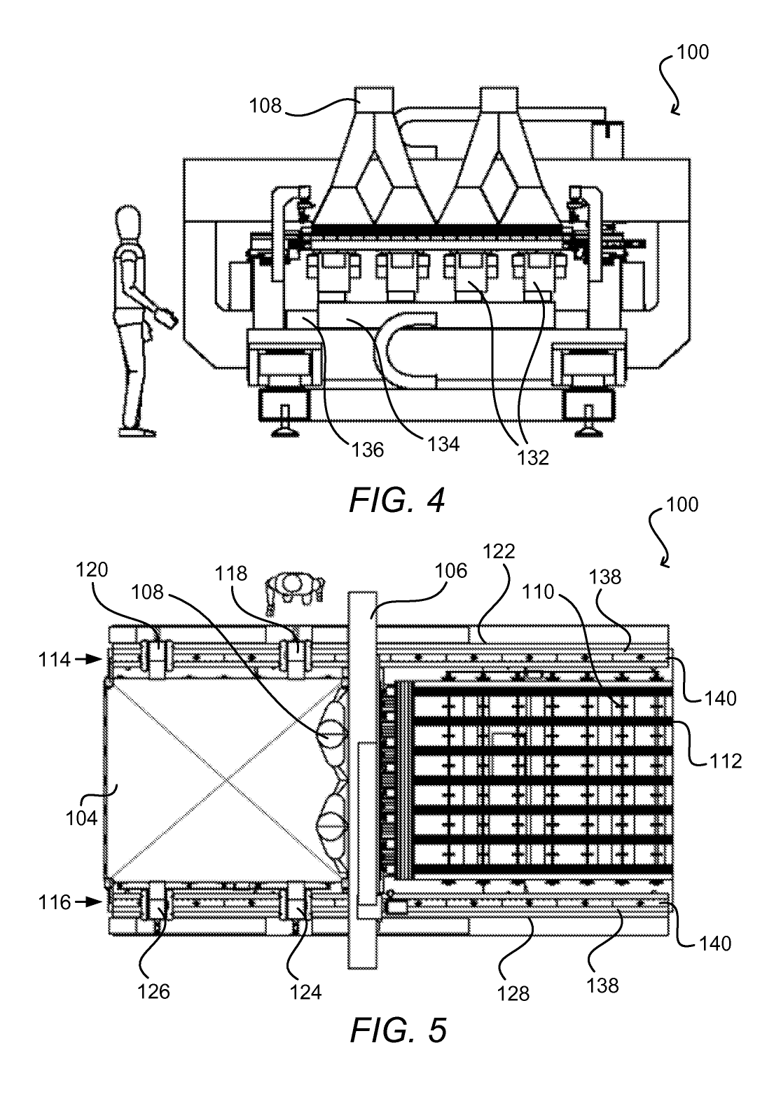

FIG. 4 illustrates an end view of the system 100, illustrating a series of laser assemblies 132 used to scribe the layers of the workpiece. While any number of laser assemblies 132 can be employed, in this specific example, there are four laser assemblies 132. Each of the laser assemblies 132 can include a laser device and elements, for example, lenses and other optical elements, needed to focus or otherwise adjust aspects of the laser. The laser device can be any appropriate laser device operable to ablate or otherwise scribe at least one layer of the workpiece, for example, a pulsed solid-state laser. As can be seen, a portion of the exhaust 108 is positioned opposite each laser assembly relative to the workpiece, in order to effectively exhaust material that is ablated or otherwise removed from the workpiece via the respective laser device. In many embodiments, the system is a split-axis system, where the stage 102 translates the workpiece 104 along a longitudinal axis (e.g., right to left in FIG. 3). The lasers and optics can be attached to a translation mechanism able to laterally translate the laser assemblies 132 relative to the workpiece 104 (e.g., right to left in FIG. 4). For example, the laser assemblies can be mounted on a support or platform 134 that is able to translate on a lateral rail 136, or using another translation mechanism, for example, a translation mechanism that may be driven by a controller and servo motor. In one system, the lasers and laser optics all move together laterally on the support 134 along with the center portion of the bed and the exhaust. This allows shifting scan areas laterally, while maintaining a small beam path and keeping the exhaust directly above the portions of the workpiece being ablated by the lasers. In some embodiments, the lasers, optics, center stage portion, and exhaust are all moved together by a single arm, platform, or other mechanism. In other embodiments, different components translate at least some of these components, with the movement being coordinates by a controller for example, as described in U.S. Patent Pub. No. 2009/0321397 A1, which has been previously incorporated herein by reference (via an above statement).

FIG. 5 illustrates a top view of system the 100 showing components of the Y-direction stages 114, 116. The Y-direction stage Y1 114 includes an X-direction stages XA1 118 and XA2 120, which translate along the Y1-stage support 122. The Y-direction stage Y2 116 includes an X-direction stages XB1 124 and XB2 126, which translate along the Y2-stage support 128. Each of the Y-direction stages 114, 116 includes a linear motor having a magnetic channel 138 disposed within the top portion of Y-direction stage supports 122, 128. Each of the Y-direction stages 114, 116 also includes a position sensing system, which includes an encoder strip 140 disposed on the respective Y-direction stage support 122, 128. Each of the Y-direction stages 114, 116 includes a reader head for monitoring the position of the Y-direction stage via reading the respective encoder strip 140.

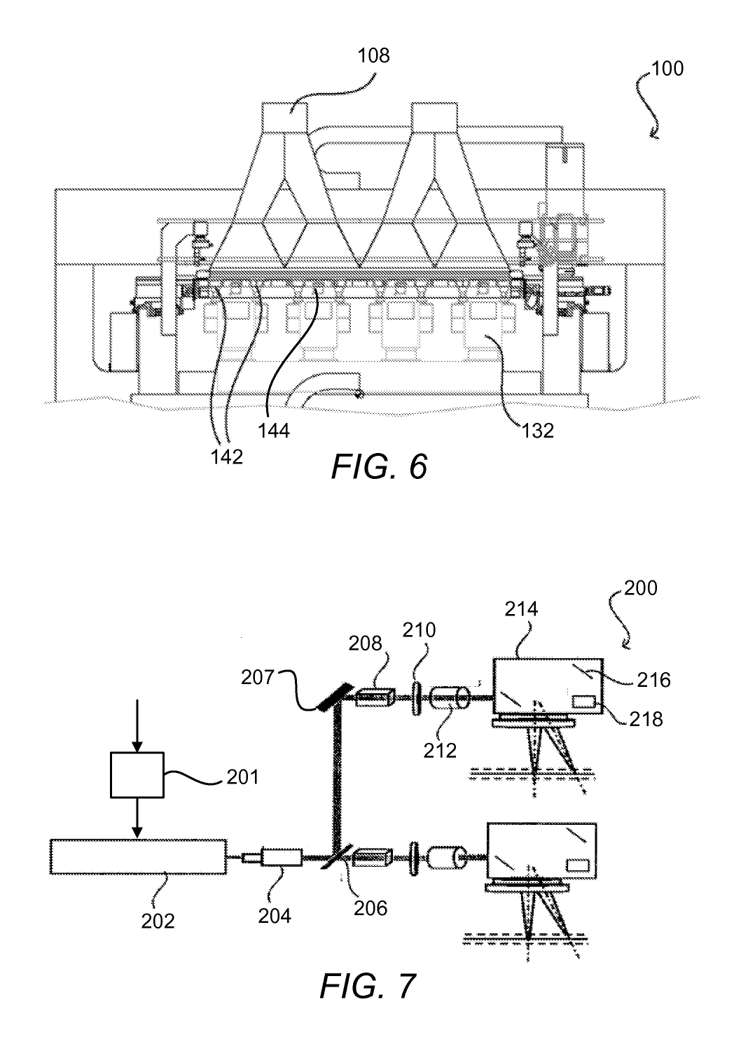

FIG. 6 is a focused view of system the 100 showing that each laser device of the system 100 actually produces two effective beams 142 useful for scribing the workpiece. In other embodiments, each laser device can be used to produce any number of effective beams, for example, two, three, or more effective beams. In order to provide the pair of beams, each laser assembly 132 includes at least one beam splitting device. As can be seen, each portion of the exhaust 108 covers a scan field, or an active area, of the pair of beams in this example, although the exhaust could be further broken down to have a separate portion for the scan field of each individual beam. Each beam in this example passes between air bearings of the bed, and the beam position between the air bearings is retained during lateral translation of the moveable center section, lasers, and optics.

Substrate thickness sensors 144 provide data that can be used to adjust heights in the system to maintain proper separation from the substrate due to variations between substrates and/or in a single substrate. For example, each laser can be adjustable in height (e.g., along the z-axis) using a z-stage, motor, and controller, for example. In many embodiments, the system is able to handle 3-5 mm differences in substrate thickness, although many other such adjustments are possible. The z-motors also can be used to adjust the focus of each laser on the substrate by adjusting the vertical position of the laser itself. A desired vertical focus of each laser can be used to selectively ablate one or more layers of the workpiece by concentrating the beam at the desired vertical position or range of vertical positions so as to produce the desired ablation. By adjusting the focus of each laser to local variations of the workpiece, more consistent line widths and spot shapes can be achieved.

FIG. 7 diagrammatically illustrates basic elements of a laser assembly 200 that can be used in accordance with many embodiments, although it should be understood that additional or other elements can be used as appropriate. In assembly 200, an input control device 201 is operatively coupled with a single laser device 202 so as to set an input signal to the laser device 202 to control the optical power output from the laser device 202 (e.g., a control signal, for example, for an attenuator; an input current; an input power, etc.). In many embodiments, the input control device 201 comprises a current measuring device and the supplied power is calculated using the measured current using known approaches (e.g., in conjunction with device voltage, resistance, etc.). The laser device 202 generates a beam that is expanded using a beam expander 204 then passed to a beam splitter 206, for example, a partially transmissive mirror, half-silvered mirror, prism assembly, etc., to form first and second beam portions. One or more of the beam portions can be redirected by a mirror 207. In this assembly, each beam portion passes through an attenuating element 208 to attenuate the beam portion, adjusting an intensity or strength of the pulses in that portion, and a shutter 210 to control the shape of each pulse of the beam portion. Each beam portion then also passes through an auto-focusing element 212 to focus the beam portion onto a scan head 214. Each scan head 214 includes at least one element capable of adjusting a position of the beam, for example, a galvanometer scanner useful as a directional deflection mechanism. In many embodiments, this is a rotatable mirror able to adjust the position of the beam along a latitudinal direction, orthogonal to the movement vector of the workpiece 104, which can allow for adjustment in the position of the beam relative to the workpiece.

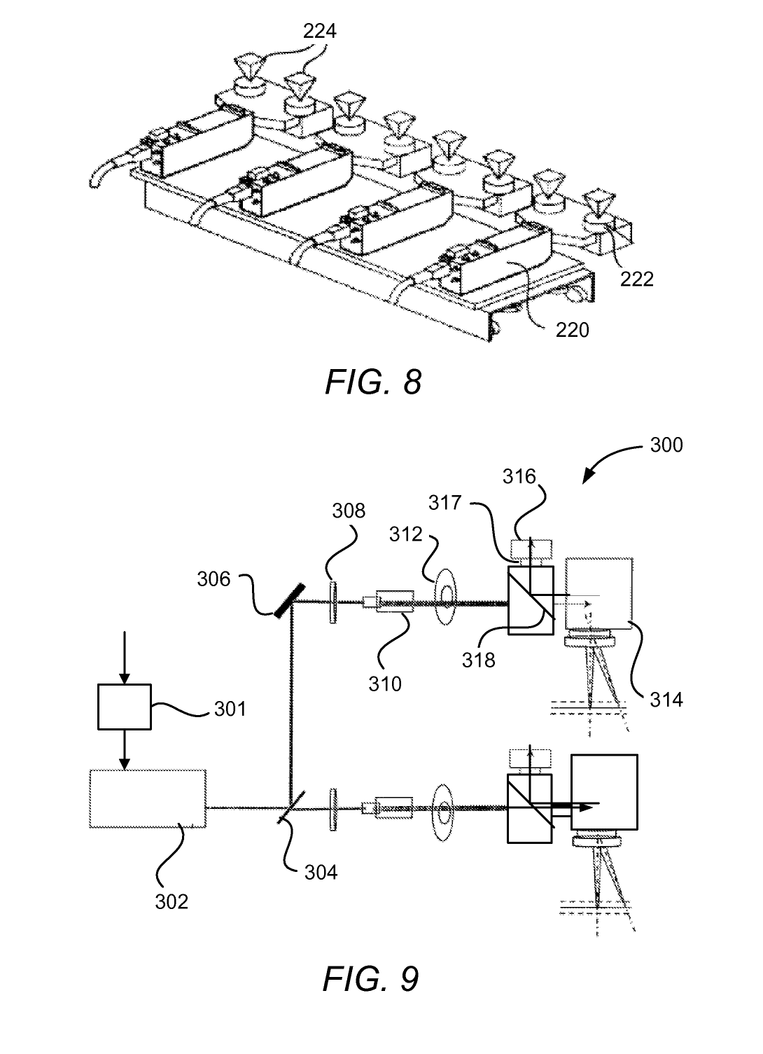

In many embodiments, each scan head 214 includes a pair of rotatable mirrors 216, or at least one element capable of adjusting a position of the laser beam in two dimensions (2D). Each scan head includes at least one drive element 218 operable to receive a control signal to adjust a position of the “spot” of the beam within a scan field and relative to the workpiece. Various spot sizes and scan field sizes can be used. For example, in some embodiments a spot size on the workpiece is on the order of tens of microns within a scan field of approximately 60 mm×60 mm, although various other dimensions and/or combinations of dimensions are possible. While such an approach allows for improved correction of beam positions on the workpiece, it can also allow for the creation of patterns or other non-linear scribe features on the workpiece. Further, the ability to scan the beam in two dimensions means that any pattern can be formed on the workpiece via scribing without having to rotate the workpiece. For example, FIG. 8 illustrates a perspective view of example laser assemblies. A pulsed beam from each laser 220 is split along two paths, each being directed to a 2D scan head 222. As shown, the use of a 2D scan head 222 results in a substantially square scan field for each beam, represented by a pyramid 224 exiting each scan head 222. By controlling a size and position of the square scan fields relative to the workpiece, the lasers 220 are able to effectively scribe any location on the substrate while making a minimal number of passes over the substrate. If the positions of the scan fields substantially meet or overlap, the entire surface could be scribed in a single pass of the substrate relative to the laser assemblies.

FIG. 9 diagrammatically illustrates a laser assembly 300, in accordance with many embodiments. The laser assembly 300 is similar to the laser assembly 200 of FIG. 7, but includes two integrated imaging devices for imaging features of the workpiece. The laser assembly 300 includes a laser device 302. The laser device 302 can include various related devices and features. For example the laser device can include an internal power meter for monitoring the optical power output of the laser. As a further example, the laser device can include an attenuation adjustment, for example, manual attenuation adjustment between two levels (e.g., between 5% and 95%). A beam generated by the laser device 302 can be split into first and second beam portions by a beam splitter 304, for example, a partially transmissive mirror, half-silvered mirror, prism assembly, etc. In some embodiments, the beam splitter 304 can be manually adjusted so as to vary the relative portions of the beam generated by the laser device 302 that makes up the first and second beam portions (e.g., from 45% to 55% in a particular beam). Each beam portion passes through a shutter 308 to control the shape of each pulse. The shutter 308 can be selected to have a sufficiently fast speed necessary to accomplish a desired shaping of each pulse. For example, in some embodiments the shutter 308 can be selected to have a speed of 50 msec or less. Each beam portion also passes through a collimator 310. Various collimators can be used. For example, a 3-4× up-collimator with plus- or -minus 1 mm manual focus adjustment can be used. Each beam portion also passes through a beam shaping element 312, for example, a beam shaping element with an aperture of 2 mm, which shapes each beam portion prior to being provided to each of scanners 314, which can be similar to the scanners 214 of FIG. 7. Two imaging devices 316 are integrated with the system 300 so as to view the workpiece through the scanners 314. In many embodiments, the integration of the imaging devices 316 includes a focusing mechanism 317. In many embodiments, the focusing mechanism 317 comprises a manually operated mechanism. In many embodiments, the focusing mechanism 317 comprises a driven mechanism (e.g., a piezoelectric mechanism, a motor driven mechanism, etc.). The light reflected from features on the workpiece enters each of the scanners 314, where it is redirected by the scanner towards a dichromatic beam splitter 318. Each dichromatic beam splitter 318 redirects the reflected light towards one of the imaging devices 316, for example, a charge-coupled device (CCD) camera, a complementary metal-oxide-semiconductor (CMOS) device, or a position sensitive detector (PSD). As shown, each of the imaging devices 316 can be integrated using the dichromatic beam splitter 318 so as to provide an imaging device view direction that substantially corresponds with the direction along which a separate laser beam portion is provided to each of the scanners 314. Although a range of relative positions can be practiced, an imaging device 316 can be integrated so that the center of its view and the output of the scribing laser 302 point at the same position on the workpiece being targeted by the scanner 314.

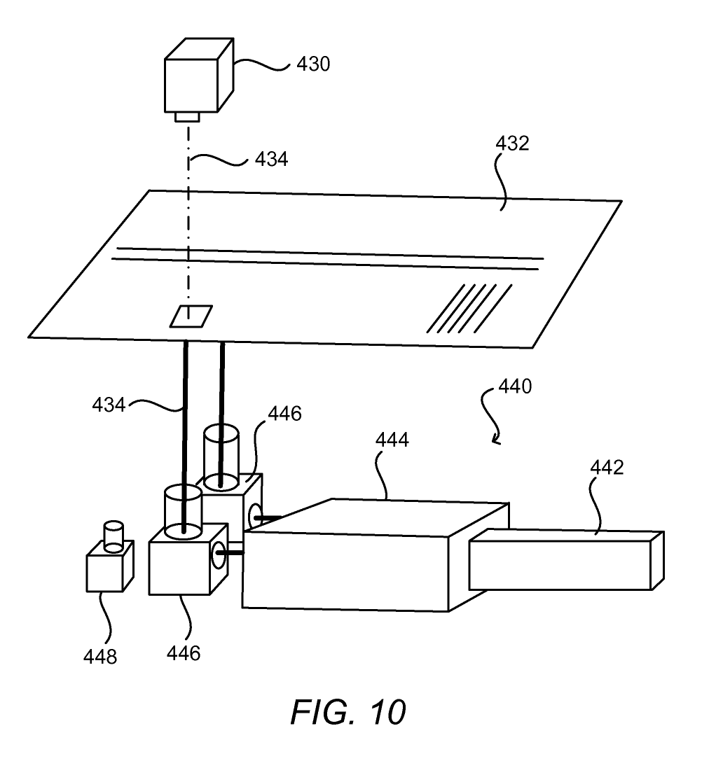

A laser-scribing system can include a number of components useful for controlling the scribing of laser lines on a workpiece. For example, as illustrated in FIG. 10, a beam viewer 430 can be used to measure the position of the output from the laser. Data from the beam viewer 430 can be used for rapid recalibration of the beam position. As illustrated, the beam viewer 430 can be positioned over a workpiece 432 so as to capture the position of a beam 434 as it passes through the workpiece 432. The expected and the actual position of the beam 434 can be compared to calculate a correction, which can provide a highly accurate adjustment for the correction of any drifts that occur. The beam measured can be projected by a laser assembly 440 that includes a laser 442, beam split optics 444, and scanners 446. As discussed above, the laser assembly 440 can be located on an optics gantry (not shown). A power meter (not shown) can also be positioned on the optics gantry for monitoring the laser power incident on the glass. A microscope (not shown) can also be used. A primary function of the microscope is calibration and alignment of the glass. The microscope can also be used to observe the scribe quality and measure the size of ablation spots. A line sensor 448 can also be used to generate location data for previously formed features. The line sensor 448 can be located in a number of locations from which it can view the previously formed features, for example, beneath the workpiece 432 as illustrated.

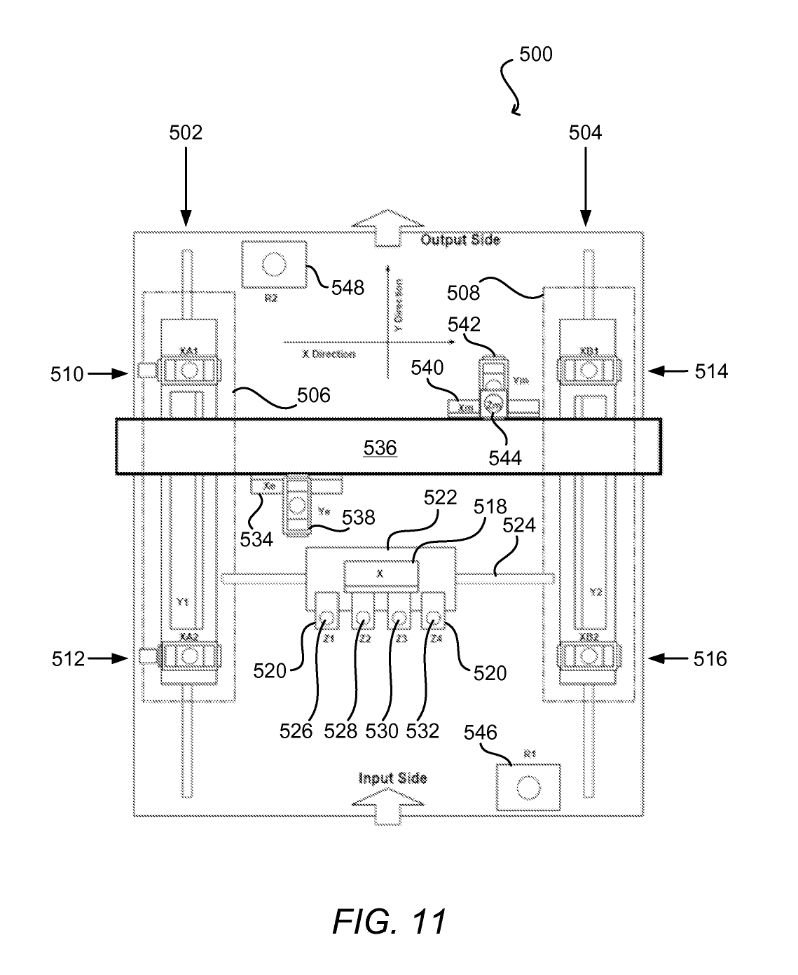

In accordance with many embodiments, FIG. 11 diagrammatically illustrates a system 500 that includes various stages that can be used to move scribing device components. As will be described in more detail below, the various stages provide for movement of the workpiece, the laser-scribing assemblies, the exhaust assembly and the microscope.

Stages Y1 502, Y2 504 can be used to provide for Y-direction movement of a workpiece during laser scribing. The stages Y1 and Y2 each can include a linear motor and one or more air bearings for y-direction travel along Y-stage supports 506, 508. Each linear motor can include a magnetic channel and coils that ride within the magnetic channel. For example, the magnetic channel can be integrated into the Y-stage supports 506, 508, which are preferably precisely manufactured so as to be within predetermined straightness requirements. The supports 506, 508 can be made from a suitable material, for example, granite. The stages Y1 and Y2 are the main Y-direction controls for the movement of the workpiece. There is no mechanical connection between the Y1 and Y2 stages when no workpiece is loaded. When a workpiece is loaded, the Y1 stage can be the master and the Y2 stage can be the follower.

Each of the stages Y1, Y2 can include a position-sensing system, for example, an encoder strip and a read head. An encoder strip can be mounted to each of supports 506, 508 and read heads can be mounted to moving portions of the stages Y1 and Y2, for example, a moving carriage for the Y1 and a moving carriage for the Y2. Output from the read heads can be processed for controlling the position, speed, and/or acceleration of each of the Y-stages. An example read head is a Renishaw Signum RELM Linear encoder readhead SR0xxA, which can be coupled with Interface unit Si-NN-0040. The SROxxA is a high resolution analog encoder read head. The Interface unit Si-NN-0040 buffers analog encoder signals and generates 0.5 um digital encoder signals. The read head and interface unit are available from Renishaw Inc., 5277 Trillium Blvd., Hoffman Estates, Ill. 60192.

Stages XA1 510 and XA2 512 are mounted for movement with the stage Y1 and provide for finely tuned X-direction control for the workpiece as it is being translated in the Y-direction by the Y stages. Such X-direction control can be used to compensate for straightness deviations of support 506. An external laser measurement system (with straightness and yaw optics/interferometer) can be used during initial calibration to measure straightness and yaw data for the master stage (Y1 stage). The measured data can be used to create error tables, which can be used to supply correction data into a motion controller for use during the Y-direction movement of the workpiece. The XA1, XA2 stages are coupled with the Y1 stage. The stages XA1, XA2 can each include a ball screw stage and be mounted on the Y1 stage with dual-loop control (e.g., rotary and linear encoders) for high accuracy and repeatability. The stages XA1, XA2 can each carry a workpiece gripper module. Each gripper module can include one or more sensors for detecting a position of the gripper module (e.g., open, closed). Each gripper module can also include one or more banking pins for controlling the amount of the workpiece held by the gripper module.

Stages XB1 514, XB2 516 are mounted for movement with the stage Y2. The stages XB1, XB2 can each include a workpiece gripper module, such as the above described gripper module. The stages XB1, XB2 can include a linear stage that can be controlled with an open-loop control system so as to maintain a desired level of tension across a workpiece.

An X laser stage 518 can be used to provide for X-direction movement of laser assemblies 520 during laser scribing of a workpiece. The X laser stage can include a linear motor and one or more air bearings for travel of a laser assembly support 522 along a support rail 524. The laser assembly support 522 can be precision fabricated from a suitable material, for example, granite. The linear motor can include a magnetic channel integrated with the support rail and coils that ride within the magnetic channel.

Z-direction stages Z1 526, Z2 528, Z3 530, and Z4 532 can be used to adjust the vertical positions of the laser assemblies. Such position adjustment can be used for a variety of purposes, such as those discussed above with reference to FIG. 6.

An Xe exhaust stage 534 can be used to provide for X-direction movement of an exhaust assembly during laser scribing of a workpiece. The Xe exhaust stage can include a linear stage mounted to a side (e.g., front side as shown) of a bridge 536. The bridge can be fabricated from a suitable material, for example, granite. A Ye exhaust stage 538 can be used to provide for Y-direction movement of the exhaust assembly. Such Y-direction movement can be used to move the exhaust assembly away from a laser-scribing area so as to allow inspection of the laser-scribing area with a microscope. The Ye exhaust stage can include a linear actuator, for example, a ball screw actuator.

An Xm microscope stage 540 can be used to provide for X-direction movement of a microscope. The Xm stage can include a linear stage and can be mounted to a side of the bridge 536, for example, the back side as shown. A Ym microscope stage 542 can include a linear stage and be mounted to the Xm stage. A Zm microscope stage 544 can include a linear stage and be mounted to the Ym stage. The combination of the Xm, Ym, and Zm stages can be used to reposition the microscope to view selected regions of a workpiece.

Roller stages R1 546 and R2 548 can be used to load and unload a workpiece, respectively. The R1, R2 roller stages can be configured to be raised relative to an air bearing bed (not shown) during the loading and unloading sequences. For example, the roller stage R1 546 can be in a raised position while a workpiece is being loaded. The roller stage R1 can then be lowered to place the workpiece on the air bearing bed. The workpiece can then be grasped by the gripper modules of stages XA1, XA2, XB1, and XB2. During unloading the sequence can be reversed, such that the workpiece is released from the gripper modules and the roller stage R2 548 can then be raised to lift the workpiece from the air bearing bed.

Power Meter Based in-Line Metrology

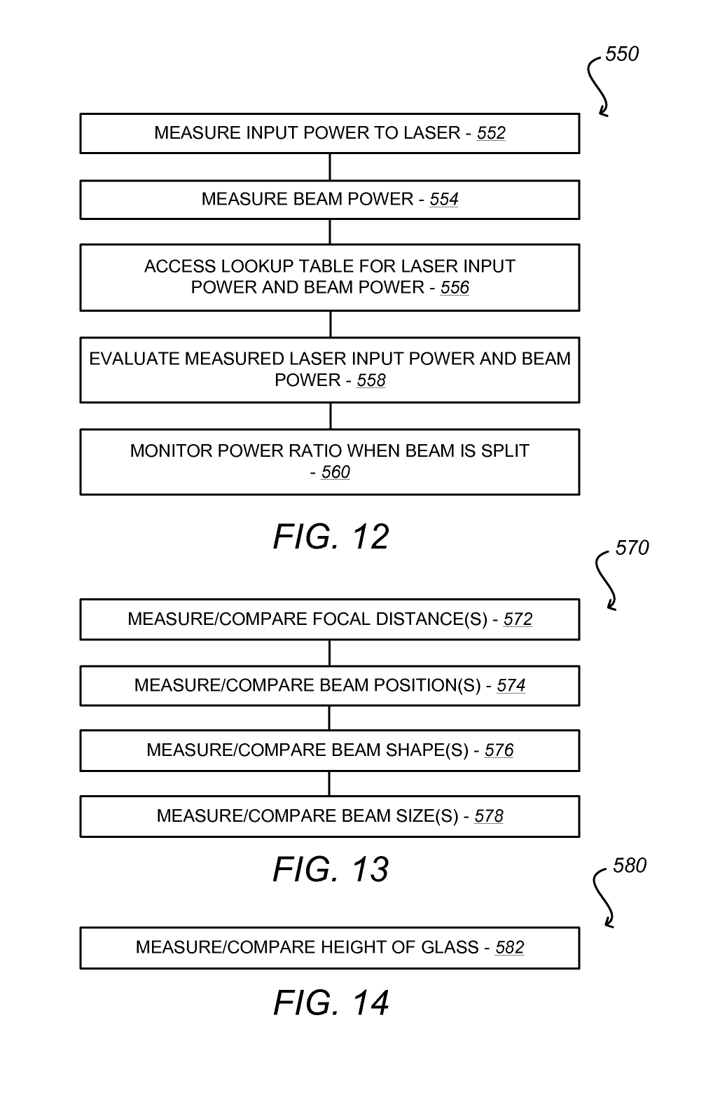

A power meter can be used to measure the output power of a laser, and this measurement can be used to monitor the laser-scribing system. FIG. 12 is a flow chart of a method 550 for using a power meter for inline metrology in a laser-scribing system, in accordance with many embodiments. In step 552, input power to a laser is measured (e.g., using the power measuring device 201, 301 discussed above with reference to FIG. 7 and FIG. 9, respectively). In many embodiments, the input power is measured by measuring input current to the laser and calculating the input power, for example, by using device voltage or resistance in combination with the measured input current. In many embodiments, the input power is determined on a laser pulse basis. In step 554, the laser beam output power is measured with a power meter. In step 556, a lookup table is accessed to obtain laser input power and laser output power values for use in evaluating the corresponding measured values. For example, the measured input power can be used to access the lookup table so as to determine an expected range of laser output power values. In step 558, the measured input power to the laser and the measured output power are evaluated relative to a lookup table values so as to determine whether the laser is functioning within operational limits. For example, the measured output power can be compared with the expected range of laser output values. As another example, the laser input power can be compared with an expected range of laser input power for the laser settings involved. One or more ranges can be used to assess whether the laser is functioning within operational limits, for example, a first range within which the laser is operating within normal operational limits. A warning message can be annunciated and/or stored and/or system shutdown can be accomplished upon violation of the first range. As a further example, a malfunction message can be annunciated and/or stored and/or system shutdown can be accomplished upon violation of a greater range than the first range. In step 560, the relative distribution between two or more output beams can be used to monitor the power ratio between split beam portions, which can be used to monitor the components used to split the beam.

Beam-Viewer Based in-Line Metrology

A beam viewer (e.g., the beam viewer 430 discussed above with reference to FIG. 10) can be used to measure various aspects of a laser beam, and these measurements can be used to monitor corresponding aspects of a laser-scribing system. FIG. 13 is a flow chart of a method 570 for using a beam viewer for inline metrology in a laser-scribing system, in accordance with many embodiments.

In step 572, the beam viewer is used to determine one or more laser-scanning assembly focal distances by measuring the size of the beam at a number of distances away from the one or more laser-scanning assemblies. The determined focal distance(s) can be compared with expected operational ranges, as well as be compared against each other where two or more laser assemblies are measured. Expected operational ranges can include a warning range and/or a fault range. The determined focal distance(s) can be monitored over time for any variation over time. Such variation may be indicative of a developing problem, and can be used to trigger maintenance and/or inspection.

In step 574, the beam viewer is used to measure a beam position(s). The measured beam position(s) can be compared against an associated commanded position(s) to determine an amount of variance. In many embodiments, such a variance measurement can be used to determine a calibrating adjustment so that a resulting position more closely matches a commanded position. In many embodiments, such a variance measurement can be compared against an acceptable variance range so that a warning message/signal can be annunciated and/or stored upon violation of the acceptable variance range. In many embodiments, such a variance measurement can be monitored for variation over time, which can be used to flag a developing problem so that timely corrective action can be taken (e.g., inspection, maintenance, etc.).

In step 576, the beam viewer is used to measure beam shape(s). For example, the beam viewer can measure the roundness of a beam. The measured shape can be compared against a nominal shape range so as to determine whether the measured shape is within operational limits.

In step 578, the beam viewer is used to measure beam size(s). For example, the beam viewer can be used to measure beam diameter(s) at the focal point(s). The measured beam diameter(s) can be compared against operational ranges, for example, a warning range and/or a fault range. Measured beam diameters can be compared against each other. Such comparisons can be used to trigger maintenance and/or inspection of the laser-scanning system, especially of beam size related components.

Height Sensor Based in-Line Metrology

A height sensor can be used to measure a distance to a workpiece, and such a measurement can be used to monitor the operation of workpiece translation stage components. FIG. 14 is a flow chart of a method 580 for using a height sensor for inline metrology in a laser-scribing system, in accordance with many embodiments. In step 582 a height sensor is used to measure a distance to the workpiece. Such a measurement can be compared against an operational range, for example, a warning range and/or a fault range. Violation of the warning and/or the fault range can be used to trigger maintenance and/or inspection of the laser-scanning system, for example, of translation stage components.

Microscope Based in-Line Metrology

A microscope (e.g., a microscope mounted for movement via the Xm microscope stage 540, the Ym microscope stage 542, and the Zm microscope stage 544 discussed above with reference to FIG. 11) can be used to accomplish a variety of measurements of workpiece features formed by a laser-scribing system, and thereby provide measurement data that can be used to monitor the operation of the laser-scribing system. FIG. 15 is a flow chart of a method 590 for using a microscope for inline metrology in a laser-scribing system, in accordance with many embodiments. In many embodiments, an imaging device is coupled with the microscope so as to be operable to capture an image of the workpiece through the microscope. Automated processing of one or more of these captured images can be used to accomplish the steps of method 590.

In step 592, the microscope is used to measure an ablation spot size and/or shape. This measurement can be compared against an operational range(s) so as to trigger maintenance and/or inspection upon violation of the operational range(s).

In step 594, the microscope is used to calibrate the location of the center of a scanning field(s) of one or more laser-scanning assemblies. For example, a laser-scanning assembly can be used to project a laser pulse (or form a laser-scribed reference feature such as a cross) at its center of scan and the microscope can be used to measure the location of the resulting ablated spot or feature. This measurement can then be used to calibrate the center of field(s) for the one or more laser-scanning assemblies.

In step 596, the microscope is used to align two or more scanners. For example, each of the two or more scanners can be used to form a reference feature on the workpiece (e.g., a cross, etc.) using a common scanner position and the microscope can be used to measure the location of the two or more features. The measured positions of the features can be used to align the scanners.

In step 598, the microscope is used to determine a positional reference between the microscope and one or more scanners. For example, the microscope can be mounted on one or more movement stages (e.g., the microscope movement stages discussed above with reference to FIG. 11) so that the microscope can be moved to various commanded positions relative to the workpiece. By positioning the microscope at a commanded position and using the microscope to measure a position of a workpiece feature relative to the microscopes commanded position, the measurement and the microscopes commanded position can be processed in conjunction with the commanded scanner position and commanded workpiece position used to form the feature so as to determine the positional reference between the microscope and the scanner(s).

In step 600, the microscope is used to pre-verify scribing. For example, the laser-scribing system can be programmed to scribe a pattern of scribe lines and used to scribe the pattern on a test workpiece. The microscope can then be used to pre-verify the resulting pattern on the test workpiece so as to verify that the laser-scribing system is ready for production scribing of the pattern.

In step 602, the microscope is used to measure scribe lines. For example, the microscope can be used to measure the position of multiple locations along a scribe line so that the path of the scribe line can be characterized along a length of the scribe line (e.g., angle, waviness, location, etc.).

In step 604, the microscope is used to measure scribe line spacing. Such measurements can be used to monitor the operation of the laser-scribing system so as to trigger maintenance and/or inspection when operational limits are exceeded. Such measurements can also be used to control the formation of subsequently scribed lines so as to more closely form the subsequently scribed lines at a controlled separation with a previously scribed line.

In step 606, the microscope is used to identify workpiece patterns. In many embodiments, a known pattern recognition algorithm (e.g., an existing pattern recognition software) is used to identify one or more workpiece patterns. Such pattern recognition can be used to accomplish one or more of the steps of method 590.

In step 608, an image captured using the microscope is magnified. Such magnification can be used during the processing of relatively small workpiece features.

In-Line Beam Drift Monitoring

The position of a laser-scribing system output scribing beam may be subject to drift over time due, for example, to component degradation over time. Such drift can be tracked in-line using an integrated imaging device (e.g., the imaging device 316 as discussed above with reference to FIG. 9). As will be discussed below in more detail, reflections of the output scribing beam from the workpiece glass substrate can be captured by the imaging device. The location of the reflections within the captured images (e.g., pixel center-of-area locations) can be monitored to detect drift in the location of the output beam relative to the scanner.

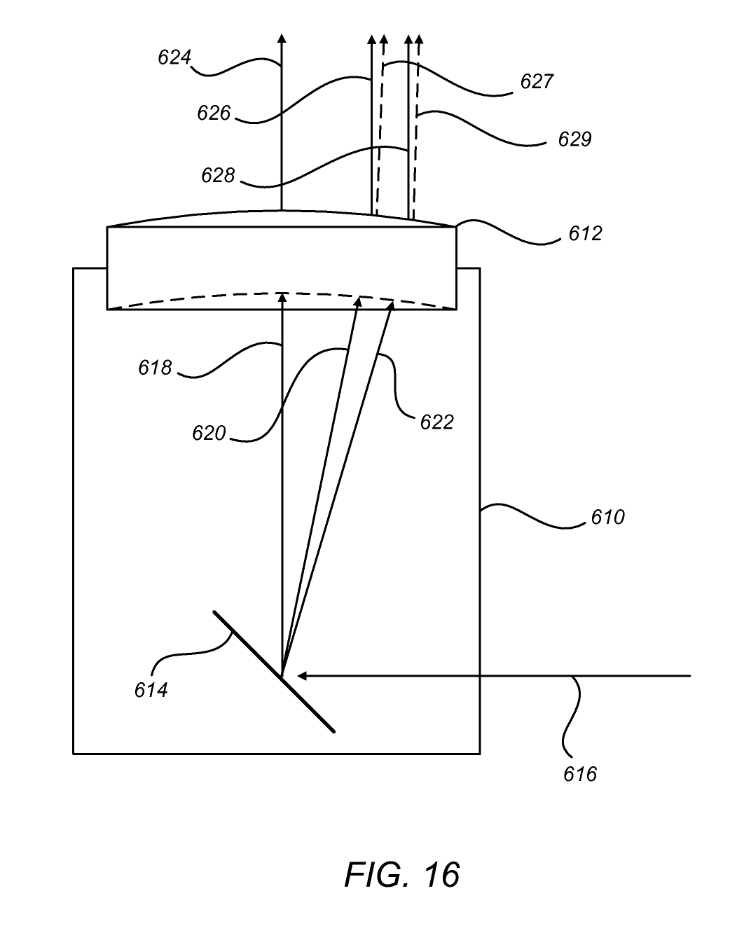

To begin a discussion of in-line beam drift monitoring, attention is now directed to FIG. 16, which diagrammatically illustrates the operation of a scanner 610 having a telecentric lens 612. The scanner 610 includes an actuated mirror 614 that is operable to deflect an incoming laser beam 616 in one or two dimensions to a range of directions relative to the mirror 614, for example, deflected beams 618, 620, 622. The direction of the deflected beams 618, 620, 622 is then altered by refraction via the telecentric lens 612 so that the beams emerge from the telecentric lens as refracted beams 624, 626, 628, respectively. With an ideal telecentric lens refraction, the emerging beams 624, 626, 628 would be parallel. However, in reality, the emerging beams 624, 626, 628 are typically not perfectly parallel, for example, due to a lens imperfection and/or due to a chromatic aberration. With regard to chromatic aberration, when the telecentric lens 612 is configured for use with a green wavelength of light so as to telecentrically refract green light beams, the telecentric lens 612 will refract longer wavelength light, for example, red light, by a greater extent (as illustrated in emerging beams 627, 629 as compared with emerging beams 626, 628, respectively).

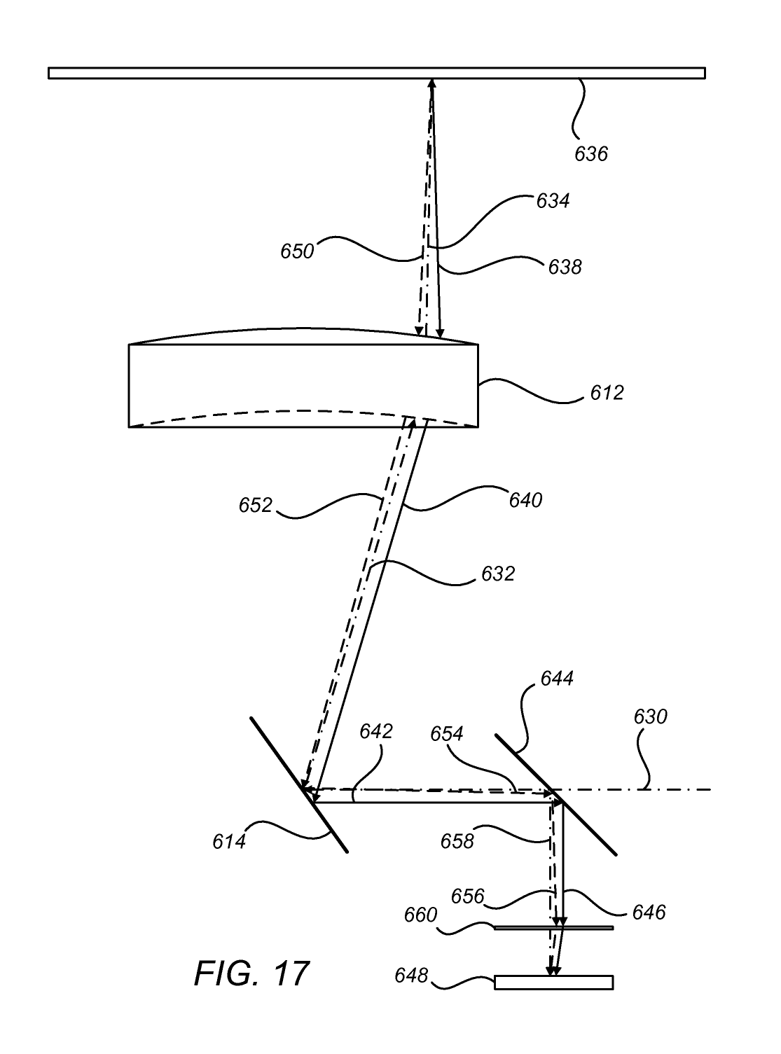

FIG. 17 diagrammatically illustrates the imaging of a reflection from a workpiece of a scanned laser beam projected from a scanner having a telecentric lens, in accordance with many embodiments. FIG. 17 is not to scale, and is intentionally exaggerated so as to provide a diagrammatic illustration of the impact of telecentric error upon the image location of a reflection of a scribing-laser pulse. In FIG. 17, an incoming laser beam 630 is deflected by the actuated mirror 614 so as to become deflected beam 632. The deflected beam 632 is refracted by the telecentric lens 612 so as to become output beam 634. In many embodiments, the telecentric lens 612 is configured to telecentrically refract green light. In many embodiments, the incoming laser beam has a green wavelength, but is not perfectly telecentrically refracted thereby causing the output beam 634 to have a slight outward direction (at least in this example and exaggerated in FIG. 17 for illustrative purposes) relative to a normal vector to a workpiece 636. Upon encountering the workpiece 636, a portion of the output beam 634 is reflected by the substrate glass surface of the workpiece to become reflected beam 638. The reflected beam 638 is then refracted by the telecentric lens 612 so as to become beam 640. The beam 640 is deflected by the actuated mirror 614 so as to become beam 642. The beam 642 is deflected by the beam splitter 644 so as to become beam 646, which redirected by a focusing element 660 so as to encounter the imaging device 648 as illustrated.

In contrast to the path traveled by the reflected green laser beam, a red light beam from the same location on the workpiece 636 travels to the imaging device 648 by a different path. In many embodiments, light with a red wavelength is used to illuminate the workpiece for imaging purposes. Accordingly, in many embodiments, the telecentric lens 612 configured to telecentrically refract a green processing laser beam will refract red light to a lesser extent. With the telecentric lens 612 configured for the green processing wavelength, the imaging device 648 would “see” a red illumination beam 650 at a different location than for the reflected green processing beam reflection 638. The red illumination beam 650 is refracted by the telecentric lens so as to become beam 652. The beam 652 is then deflected by the actuated mirror 614 to become beam 654. The beam 654 is then deflected by the beam splitter 644 to become beam 656, which is redirected by the focusing element 660 so as to encounter the imaging device 648 as illustrated.

In many embodiments, the imaging device 648 is integrated with a laser-scanning assembly so as to correct for the impact of telecentric errors. In the absence of telecentric error, the deflected (incoming) beam 632 would be telecentrically refracted by the telecentric lens 612 thereby being output normal to the workpiece 636. The output beam would then be reflected back along the same path, refracted by the telecentric lens 612 along the same path, deflected by the actuated mirror along the same path, until finally deflected by the beam splitter so as to become beam 658. Regardless of the position of the actuated mirror, in the absence of telecentric error, the incoming beam reflection would always be “seen” by the imaging device in the same location (i.e., beam 658). However, as illustrated in FIG. 17, the presence of telecentric error results in the beams encountering the imaging device along paths that are not normal to the imaging device (e.g., beam 646, beam 656). To account for these non-normal incident angles, the focusing element 660 can be used to redirect the beams 646, 656 as shown, which causes the imaging device to be “focused” for the red illumination light so that red illumination beam 656 encounters the imaging device 648 at the same location as the beam 658, substantially regardless of the position of the actuated mirror 614. The imaging device can be said to be “focused for red.” At this focus, the beam 646 (corresponding to the reflection of the incoming laser beam 630) encounters the imaging device at a location other than the location encountered by the beam 656 and beam 658. At this focus, the location at which the beam 646 encounters the imaging device will depend upon the position of the actuated mirror 614. In many embodiments, the focusing element 660 is provided by a focusing mechanism (e.g., focusing mechanism 317 discussed above with reference to FIG. 9), which can be used to focus the imaging device for a particular wavelength (e.g., red as shown, or green, blue, etc.).

In many embodiments, the above discussed telecentric error impact and related camera focusing is used to monitor output beam location, which can be used to monitor for changes in the output beam location (i.e., beam drift). As discussed above, the location of the reflection in the image captured by the imaging device 648 is a function of the position of the actuated mirror 614 at least where the imaging device is not focused for the wavelength of the reflected light being tracked (e.g., the wavelength of the incoming beam 630) and there is appreciable telecentric error for the wavelength of the reflected light being tracked. Accordingly, the reflection image positions for positions of the actuated mirror 614 can be tracked overtime so as to detect beam drift. As can be appreciated, increasing amounts of defocus of the imaging device relative to the wavelength of the reflections tracked can be used to increase the sensitivity of this tracking by increasing the amount of change of image pixel locations for different positions of the actuated mirror 614.

In many embodiments, a filter (not shown) is used to filter out wavelengths associated with an ablative emission from the workpiece caused by the output beam 634 (which corresponds to the incoming laser beam 630). Such filtering may simplify the processing of the captured image by not imaging wavelengths other than the desired processing wavelength because the other wavelengths would be travel from the workpiece to the imaging device by a different path and thereby be seen at a different pixel location despite originating from the same location on the workpiece.

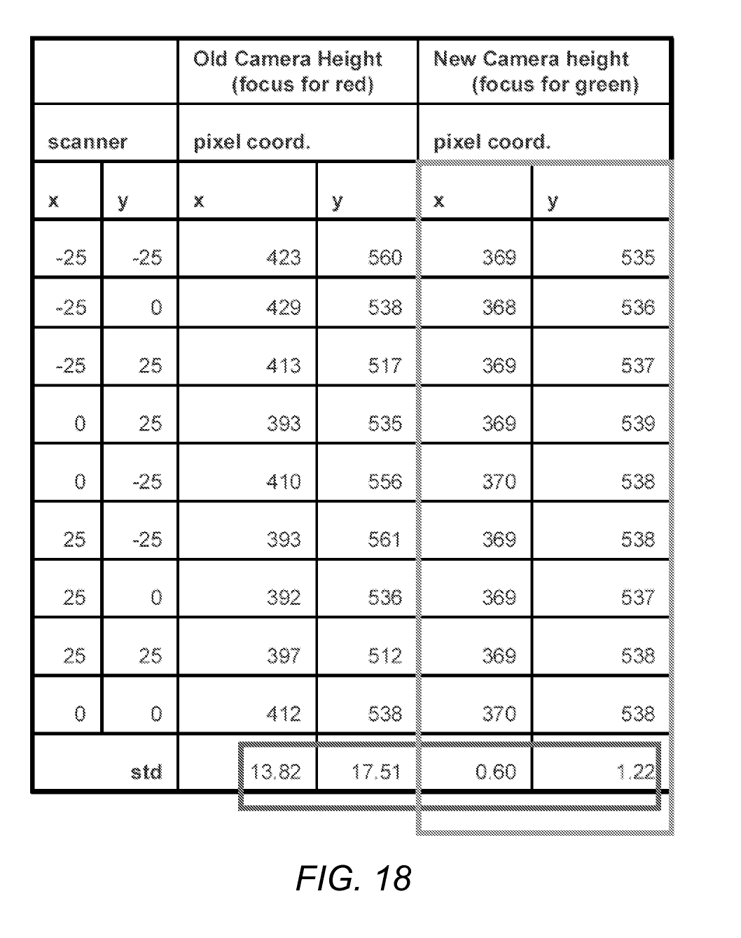

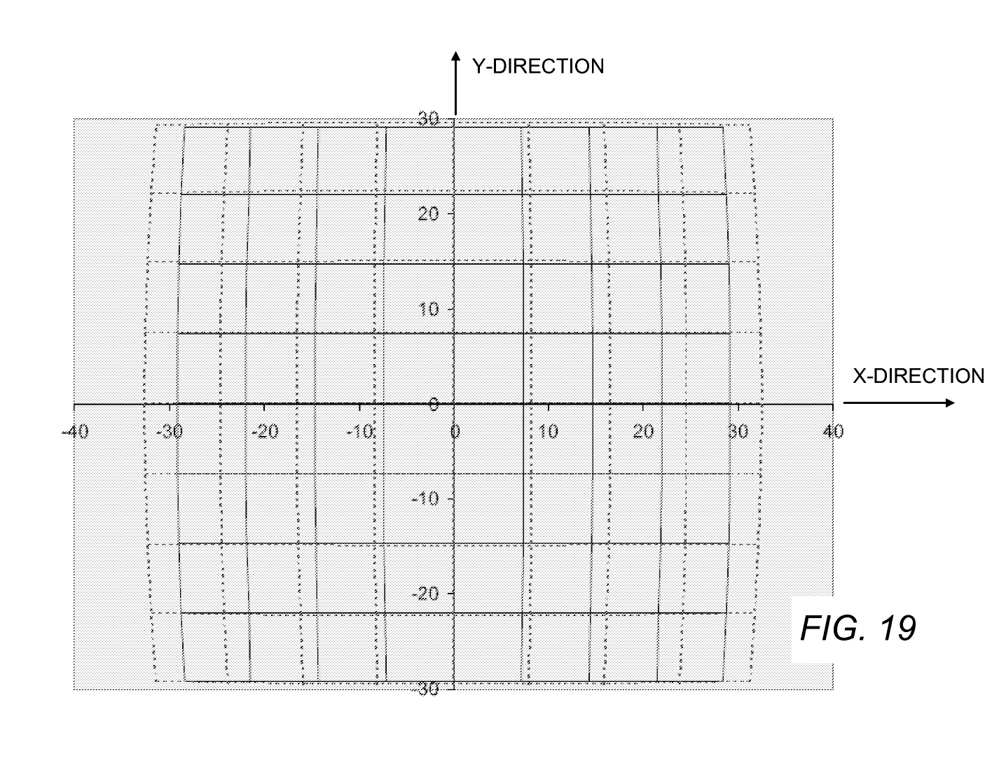

FIG. 18 is a table of image centroid pixel locations for a number of scanner positions for two different imaging device focus positions, in accordance with many embodiments. When the imaging device has a “focus for red” as discussed above, the table shows that different scanner positions (i.e., scanner x and y positions shown in the first two columns of the table) result in different pixel coordinates for the resulting image of the processing laser beam reflection (i.e., pixel coordinates for “Old Camera Height (focus for red)”) shown in the third and fourth columns of the table. When the imaging device is focused for the wavelength of the incoming laser beam, the table shows that different scanner positions result in substantially the same pixel coordinate for the resulting image of the processing laser beam reflection (i.e., pixel coordinates for “New Camera height (focus for green)”) shown in the fifth and sixth columns of the table. Accordingly, the table provides a further illustration of the impact that imaging device focus can have on the sensitivity of image pixel coordinate positions of reflection images as a function of scanner position, with increasing levels of defocus providing increasing levels of sensitivity. Thus, although beam drift monitoring may be accomplished with any appreciable level of defocus, larger amounts of defocus may be advantageous to increase sensitivity.

FIG. 19 graphically illustrates the impact of telecentricity errors in a telecentric scan lens model for 100 mm defocus, in accordance with many embodiments. For the scan lens model and defocus level illustrated, the telecentricity error is more pronounced in the x-direction (the max x-direction slope deviation from normal being approximately +/−2 degrees and the max y-direction slope deviation from normal being approximately +/−0.23 degrees), which may be attributable to the effective lens pupil being very close to the y-direction galvanometer scanner. The dashed lines illustrate the scan displacement due to the telecentricity error and the 100 mm defocus. The dashed lines represent the actual pattern when telecentric error is considered.

In-Line Auto Focus

As discussed above, when the imaging device is “focused” with respect to a particular wavelength, the pixel location of a reflection of a scanned beam having that wavelength will exhibit a minimal amount of variation with the position of the actuated mirror 614. Accordingly, the imaging device can be focused for a particular wavelength by finding the focal position that minimizes the variation in the pixel location of the image of a corresponding reflection of the wavelength for a range of scanner positions. In many embodiments, the optimal focal position is determined using an automated approach that analyzes pixel location variations for a number of focal positions and a number of scanner positions.

Laser Health Monitoring

In many embodiments, laser pulse reflections and/or ablation plume emissions are analyzed to monitor pulse-to-pulse energy stability and/or to check for missing pulses. Accordingly, a sensor (e.g., a photodiode) can be used to measure the laser pulse reflections and/or ablation plume emissions. For example, one or more sensors can be coupled with the scanning assembly so as to be in a position to measure the laser pulse reflections and/or ablation plume emissions.

Appendix A contains further discussion regarding the in-line beam drift monitoring, the in-line autofocus, and the laser health monitoring discussed above.

Imaging Device Based in-Line Metrology

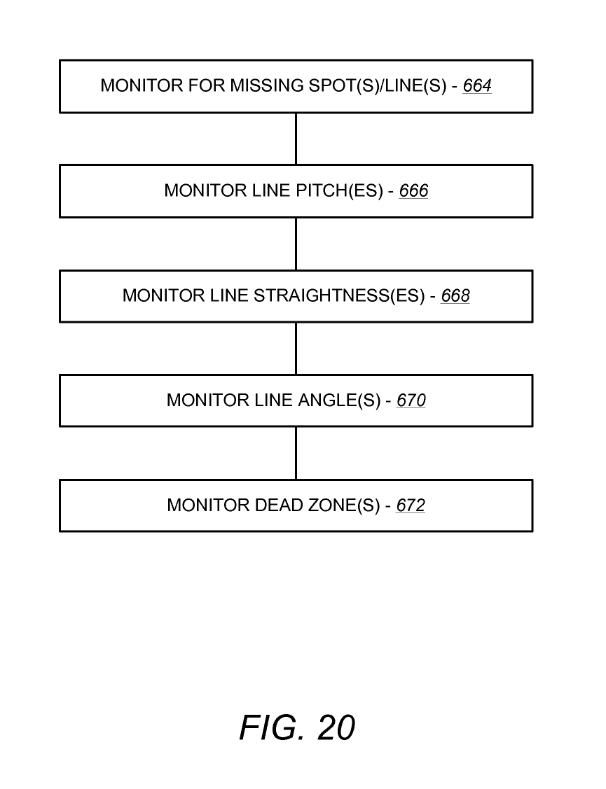

One or more images of a workpiece can be processed to provide for in-line metrology regarding the operation of a laser-scribing system. FIG. 20 is a simplified block diagram illustrating imaging device based in-line metrology operations for a laser-scribing system, in accordance with many embodiments. In operation 664, one or more images of a workpiece are processed to monitor for a missing ablation spot(s) and/or a missing scribe line(s). In operation 666, one or more images of a workpiece are processed to monitor the pitch of one or more scribe lines. In operation 668, one or more images of a workpiece are processed to monitor the straightness of one or more scribe lines. In operation 670, one or more images of a workpiece are processed to monitor the angle of one or more scribe lines. In operation 672, one or more images of a workpiece are processed to monitor the size of one or more dead zones between adjacent scribe lines. The above described monitored items can be compared against warning and/or fault ranges and a warning and/or a fault can be annunciated, stored, or otherwise processed. Such a warning or fault can be used to trigger appropriate corrective action, for example, maintenance, inspection, or other appropriate corrective action.

Appendix B contains further discussion regarding the imaging device based in-line metrology discussed above.

Monitoring System

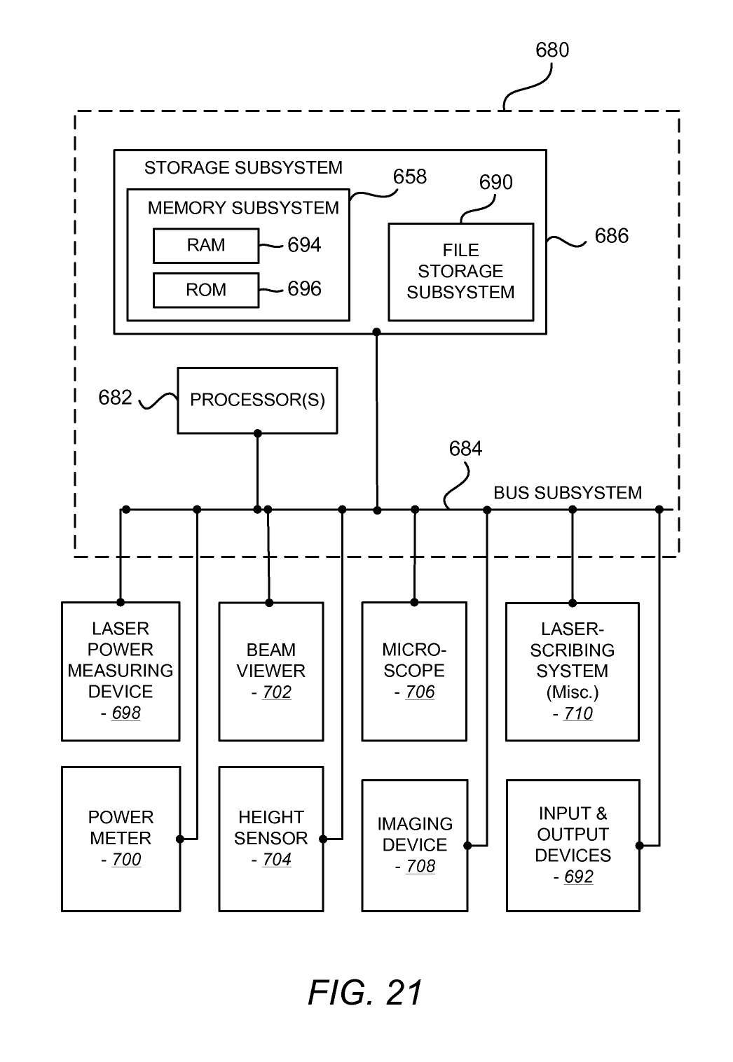

In many embodiments, a laser-scribing system includes a monitoring system for implementing the above described in-line metrology approaches and/or operations. FIG. 21 is a simplified block diagram of a monitoring system 680 that can be used. The monitoring system 680 can include at least one processor 682, which can communicate with a number of peripheral devices via bus subsystem 684. These peripheral devices can include a storage subsystem 686 (memory subsystem 688 and file storage subsystem 690) and a set of user interface input and output devices 692.

The user interface input devices can include a keyboard and may further include a pointing device and a scanner. The pointing device can be an indirect pointing device such as a mouse, trackball, touchpad, or graphics tablet, or a direct pointing device such as a touch screen incorporated into the display. Other types of user interface input devices, such as voice recognition systems, are also possible.

User interface output devices can include a printer and a display subsystem, which can include a display controller and a display device coupled to the controller. The display device can be a cathode ray tube (CRT), a flat-panel device such as a liquid crystal display (LCD), or a projection device. The display subsystem can also provide non-visual display such as audio output.

Storage subsystem 686 can maintain basic programming and data constructs that can be used to control a patterning device. Storage subsystem 686 typically comprises memory subsystem 688 and file storage subsystem 660.

Memory subsystem 688 typically includes a number of memories including a main random access memory (RAM) 694 for storage of instructions and data during program execution and a read only memory (ROM) 696 in which fixed instructions are stored.

File storage subsystem 690 provides persistent (non-volatile) storage for program and data files, and typically includes at least one hard disk drive and at least one disk drive (with associated removable media). There may also be other devices such as a CD-ROM drive and optical drives (all with their associated removable media). Additionally, the system may include drives of the type with removable media cartridges. One or more of the drives may be located at a remote location, such as in a server on a local area network or at a site on the Internet's World Wide Web.

In this context, the term “bus subsystem” is used generically so as to include any mechanism for letting the various components and subsystems communicate with each other as intended. With the exception of the input devices and the display, the other components need not be at the same physical location. Thus, for example, portions of the file storage system could be connected via various local-area or wide-area network media, including telephone lines. Bus subsystem 684 is shown schematically as a single bus, but a typical system has a number of buses such as a local bus and one or more expansion buses (e.g., ADB, SCSI, ISA, EISA, MCA, NuBus, or PCI), as well as serial and parallel ports.

Discussion of the remaining items of FIG. 21 will be omitted here due to being discussed above, such as laser power measuring device 698 (e.g., power measuring device 201 discussed above with reference to FIG. 7), power meter 700 (e.g., as discussed above with respect to FIGS. 9, 10, and 12), beam viewer 702 (e.g., beam viewer 430 discussed above with reference to FIGS. 10 and 13), height sensor 704 (e.g., discussed above with reference to FIG. 14), microscope 706 (e.g., discussed above with reference to FIGS. 10, 11, and 15), imaging device 708 (e.g., discussed above with reference to FIGS. 3, 9, 17, 18, and 20), and other miscellaneous laser-scribing system components 710. Each of the aforementioned devices can be operatively coupled with the bus subsystem 684 using an appropriate interfacing device, for example an analog to digital conversion device.

It is understood that the examples and embodiments described herein are for illustrative purposes and that various modifications or changes in light thereof will be suggested to persons skilled in the art and are to be included within the spirit and purview of this application and the scope of the appended claims. Numerous different combinations are possible, and such combinations are considered to be part of the present invention.

What is claimed is:

1. An in-line metrology method for use with a laser-scribing system, the method comprising:
setting an input signal to a laser;
measuring a first optical power of the laser corresponding to the input signal; and
comparing the first optical power to a power range corresponding to the input signal.

2. The method of claim 1, further comprising communicating a fault message when the comparison indicates that the first optical power is outside an acceptable range.

3. The method of claim 1, further comprising measuring a second optical power of the laser and determining a power ratio in response to the first and second optical powers.

4. The method of claim 3, further comprising:
comparing the second optical power to a power range corresponding to at least one of the input signal or the power ratio; and
communicating a fault message when the comparison indicates that the second optical power is outside an acceptable range.

5. An in-line metrology method for use with a laser-scribing system, the method comprising:
monitoring a laser-scanning assembly of the laser-scribing system over time by periodically measuring an output of the laser-scanning assembly; and
communicating a fault message when the measurement at least one of exceeds an acceptable range or exhibits an unacceptable rate of change.

6. The method of claim 5, wherein the measurement comprises an output beam position.

7. The method of claim 5, wherein the measurement comprises an output beam shape.

8. The method of claim 5, wherein the measurement comprises an output beam size.

9. An in-line metrology method for use with a laser-scribing system, the method comprising:
monitoring a translation stage of the laser-scribing system by periodically measuring a height of a workpiece; and
communicating a fault message when the height at least one of exceeds an acceptable range or exhibits an unacceptable rate of change.

10. An in-line metrology method for use with a laser-scribing system, the method comprising:
forming one or more features on a workpiece with the laser-scribing system;
measuring the one or more features with a microscope connected with the laser-scribing system;
using the measurements to at least one of monitor the operation of the laser-scribing system so as to detect an operational degradation of the laser-scribing system or adjust an operational parameter of the laser-scribing system.

11. The method of claim 10, wherein the measured one or more features comprise at least one of an ablation spot size or shape.

12. The method of claim 10, wherein the measurements are used to at least one of:
calibrate a center of field of a laser-scanning assembly of the laser-scribing system;
align two or more laser-scanning assemblies of the laser-scribing system;
determine a positional reference between the microscope and a laser-scanning assembly of the laser-scribing system;
pre-verify a scribing pattern;
characterize a scribe line; or
determine a spacing between scribed lines.

13. The method of claim 10, further comprising identifying a workpiece feature pattern with a pattern recognition algorithm.

14. The method of claim 10, further comprising magnifying an image of the workpiece.

15. A method for monitoring a position of an output of a light-scanning assembly comprising a scanning mechanism and a telecentric lens having a primary axis, the method comprising:
scanning light with the light-scanning assembly, wherein the light output from the light-scanning assembly comprises a telecentric error;
reflecting the light output from a surface oriented normal to the primary axis of the telecentric lens;
imaging the reflected light with an imaging device coupled with the light-scanning assembly so as to receive the reflected light after its direction has been altered by the scanning mechanism; and
monitoring a series of images captured with the imaging device so as to detect a change in location of an image of the reflected light.

16. The method of claim 15, wherein a focusing mechanism is used to alter the direction of the reflected light.

17. A method for focusing an imaging device coupled with a light-scanning assembly comprising a scanning mechanism and a telecentric lens having a primary axis, the method comprising:
scanning light with the light-scanning assembly, wherein the light output from the light-scanning assembly comprises a telecentric error;
reflecting the light output from a surface oriented normal to the primary axis of the telecentric lens;
imaging the reflected light with an imaging device coupled with the light-scanning assembly so as to receive the reflected light after its direction has been altered by the scanning mechanism; and
determining a imaging device focus for which changes in position of images of the reflected light for different positions of the scanning mechanism are substantially minimized.

18. A monitoring system for monitoring a laser-scribing system, the monitoring system comprising:
one or more devices for at least one of
measuring an operational parameter of the laser-scribing system,
measuring an output of the laser-scribing system,
measuring a feature formed by the laser-scribing system,
imaging a feature formed by the laser-scribing system, or
imaging a reflection of an output of the laser-scribing system; and
a monitoring subsystem operatively coupled with the one or more devices, the monitoring subsystem comprising a processor and a tangible medium comprising instructions that when executed cause the processor to monitor output from the one or more devices so as to detect at least one of a degradation of the system or a malfunction of the system.

19. The monitoring system of claim 18, wherein the one or more devices comprises at least one of a power measuring device, a power meter, a beam viewer, a height sensor, a microscope, or an imaging device.
